(19) United States
(12) Patent Application Publication
(10) Pub. No.: US 2005/0191527 A1
(43) Pub. Date: Sep. 1, 2005

(54) Organometallic compound containing quinoxaline structure and light emitting element

(76) Inventors: Hiroyuki Fujii, Souraku County (JP); Toshikazu Hirao, Nishinomiya-city (JP); Hidehiro Sakurai, Okazaki-city (JP); Lisheng Mao, Toyonaka-city (JP); Kazuyasu Tani, Kobe-city (JP)

Correspondence Address: KUBOVCIK & KUBOVCIK, SUITE 710, 900 17TH STREET NW, WASHINGTON, DC, 20006, US

(21) Appl. No.: 11/064,123

(22) Filed: Feb. 23, 2005

(30) Foreign Application Priority Data
Feb. 27, 2004 (JP) 2004-52742

(51) Int. Cl. B32B 9/00

(52) U.S. Cl. 428/917; 428/690

(57) ABSTRACT

An organometallic compound comprising a quinoxaline structure, and having a structure represented by the following general formula (2), 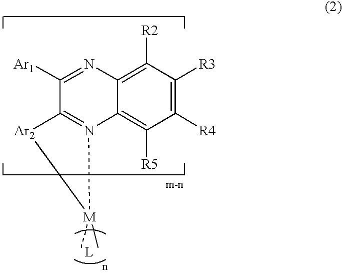
wherein M represents a monovalent to trivalent metal, L represents a ligand, Ar₁ and Ar₂ represent an aryl group in which a part of hydrogens may be substituted, and the same or different, m represents an integer of 1 to 3, n represents an integer of 0 to 2, and m-n is an integer of 1 to 3.

The priority Japanese Patent Application Number 2004-52742 upon which this patent application is based is hereby incorporated by reference.

### BACKGROUND OF THE INVENTION

1. Field of the Invention

The present invention relates to an organometallic compound containing a quinoxaline structure and a light emitting element using the same.

2. Description of the Related Art

Japanese Patent Application Laid Open No. 11-329729 discloses an organic electroluminescent element, comprising a metal complex in which a ligand having a quinoxaline skeleton is bound to a metal atom having a small atomic number such as zinc and aluminum by a coordinate bond. Generally, in a metal complex without covalent bond between a metal atom and a carbon atom, it is known that spin-orbit interaction is very small. Therefore, it is known that phosphorescence emitting phenomenon via triplet excited state by which highly effective light emitting is obtained, is manifested only at an extremely low temperature of around 77 K or lower in a metal complex without covalent bond between a metal atom and a carbon atom. In the technique disclosed in the same gazette, only very dark light emission having a maximum luminance of 9 to 45 cd/m² is obtained, an emitting peak wavelength is 585 to 619 nm, and this is dull color of orange, therefore, only light emitting property which can not be put into practice in utility of illumination and display indication was obtained. In addition, there is no disclosure on emitting efficiency, but it is presumed that an emitting efficiency is very low.

In addition, Advanced Materials, 2003, 15(3),224/228 by Prof. Chien-Hong Cheng at Tsing Hua Univ., Hsinchu, Taiwan disclosed organic light-emitting diodes using bis(dibenzo[f,h]quinoxalin-5-yl-κC5,κN4)(2,4-pentanedionato-κO,κO′)iridium [abbreviation Ir(DBQ)₂(acac)] and bis(2-methylbenzo[f,h]quinoxalin-5-yl-κC5,κN4) (2,4-pentanedionato-κO,κO′)iridium [abbreviation Ir(MDQ)₂(acac)]. Photoluminescence properties of the iridium compounds disclosed in the same article was such that an emitting peak wavelength of Ir(DBQ)₂(acac) was 618 nm, a photoluminescence quantum yield was 0.53, and an emitting peak wavelength of Ir(MDQ)₂(acac) was 608 nm, a photoluminescence quantum yield was 0.48, and both of which were light emission of orange, in a photoluminescence in a dichloromethane solution.

In addition, emitting property of the organic electroluminescent element disclosed in the same document was such that a maximum luminance was 45440 to 73870 cd/m², an emitting peak wavelength was 610 to 612 nm, x in a CIE chromaticity coordinate was 0.60 to 0.63, and y was 0.37 to 0.40, and light emission was orange.

A chromaticity coordinate defined by Commission International d'Eclairage (CIE), of a primary red prescribed by NTSC (National Television System Committee) television broadcasting standard specification which is standard in Japan and North American countries is (x=0.67, y=0.33). Therefore, in the technique disclosed in the aforementioned document, in order to put into practice in utility of display indication, only insufficient emitting property was obtained.

In Japanese Patent Application Laid Open No. 2003-40878 and 50th Organometallic Chemistry Forum Abstract, pp. 204 to 205 (published on Sep. 12, 2003), a compound having a quinoxaline structure was synthesized, and this was studied as an emitting material or a carrier transporting material of an organic electroluminescent element (organic EL element), but a metal complex and an organometallic compound using the compound are not studied.

### SUMMARY OF THE INVENTION

An object of the present invention is to provide an organometallic compound which is excellent in emitting color property and light emitting efficiency, and a light emitting element containing the organometallic compound as an emitting substance.

The organometallic compound of the present invention is characterized in that it contains a derivative which comprises a quinoxaline ring structure, and has a structure represented by the following general formula (1), 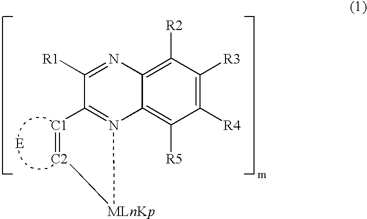
wherein M represents a monovalent to trivalent metal, L and K represent a ligand coordinating on a metal M, E represents a cyclic structure, R1 to R5 represent a hydrogen atom or an arbitrary substituent, and may be the same or different, m represents an integer of 1 to 3, n represents an integer of 0 to 3, p represents an integer of 0 to 2, and m+n+p is an integer of 2 to 5.

Examples of E in the general formula (1) include a substituted or unsubstituted aryl group, a substituted or unsubstituted heterocyclic group, a substituted or unsubstituted fused polycyclic aromatic group and a substituted or unsubstituted fused polycyclic heterocyclic group.

Examples of R1 in the general formula (1) include a substituent having a carbon number of 4 or more, such as a substituted or unsubstituted aryl group, a substituted or unsubstituted heterocyclic group, a substituted or unsubstituted fused polycyclic aromatic group and a substituted or unsubstituted fused polycyclic heterocyclic group.

In general formula (1), when ligands L and K are not coordinated, n and p are 0, and m is preferably 3.

An organometallic compound in a limited aspect of the present invention is characterized in that it contains a derivative which comprises a quinoxaline ring structure, and has a structure represented by the following general formula (2), 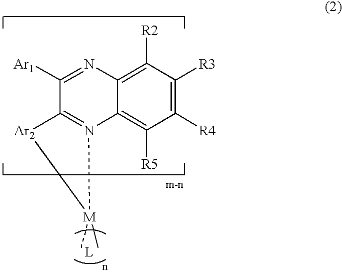
wherein M represents a monovalent to trivalent metal, L represents a ligand, Ar₁ and Ar₂ represent an aryl group in which a part of hydrogens may be substituted, and may be the same or different, m represents an integer of 1 to 3, n represents an integer of 0 to 2, and m-n is an integer of 1 to 3.

In the general formula (2), when a ligand L is not coordinated, n is 0, and m is preferably 3.

Examples of M in the general formula (1) or (2) include Ir (iridium), Pt (platinum), Re (rhenium) and Os (osmium) Ir, Re and Os are a trivalent metal, and Pt is a divalent metal.

In the general formula (2), when one organometallic compound is coordinated with plurality of ligands, ligands L may be the same or different. Examples of the ligand L include a dicarbonyl compound such as 2,4-pentanedione and a tautomer thereof.

The emitting element of the present invention is characterized in that it comprises the aforementioned organometallic compound of the present invention as a light emitting substance.

Examples of the light emitting element include an organic EL element in which an organic layer such as an emitting layer is disposed between one pair of electrodes. The aforementioned organometallic compound of the present invention may be contained as an emitting substance in this emitting layer.

The emitting element of the present invention can be applied to various element structures disclosed in Japanese Patent Application Laid Open No. 2003-7469, Japanese Patent Application Laid Open No. 8-315983, Japanese Patent Application Laid Open No. 8-319482, Japanese Patent Application Laid Open No. 11-288786, Japanese Patent No. 3208145, U.S. Pat. No. 6,008,588, U.S. Pat. No. 6,229,505 and Sergey Lamansky et al., J. Am. Chem. Soc., 2001, Vol. 123, pp. 4304-4312. In addition, an emitting element can be obtained by using the organometallic compound of the present invention in place of an emitting substance disclosed in Japanese Patent Application Laid Open No. 2002-324401 as well as Jpn. J. Appl. Phys. Vol. 40 Part 2, No. 9A/B, 2001) pp. L 945-L 947 and Jpn. J. Appl. Phys. Vol. 40 Part 2, No. 12A, (2001) pp.L 1323-L 1326.

A quinoxaline derivative used in synthesis of the organometallic compound of the present invention can be synthesized, for example, as follows and, using this derivative as a starting substance, the organometallic compound of the present invention can be synthesized, for example, as follows:

Synthesis of Quinoxaline Derivative

(i) Method by Coupling Reaction

A quinoxaline derivative can be synthesized by Suzuki coupling, in which 3,4-dihalogenated quinoxaline is allowed to react with a corresponding boronic acid (see Synthetic scheme 1 to 2). This method is not only used in synthesis of a symmetric quinoxaline derivative (see Synthetic Scheme 1), but is an optimal method for synthesis of an asymmetric quinoxaline derivative (see Synthetic Scheme 2). 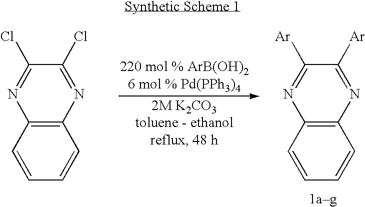 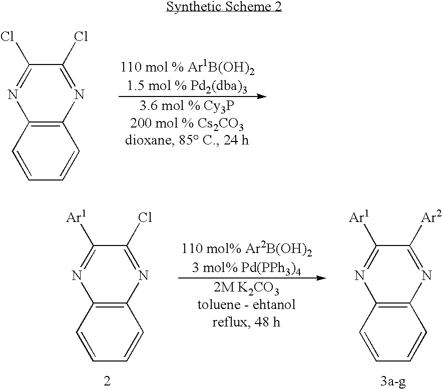
(ii) Method by Condensation Reaction

A quinoxaline derivative can be synthesized by dehydration condensation, in which 1,2-phenylenediamine is allowed to react with a corresponding 1,2-diketone compound such as benzil (see Synthetic Scheme 3). 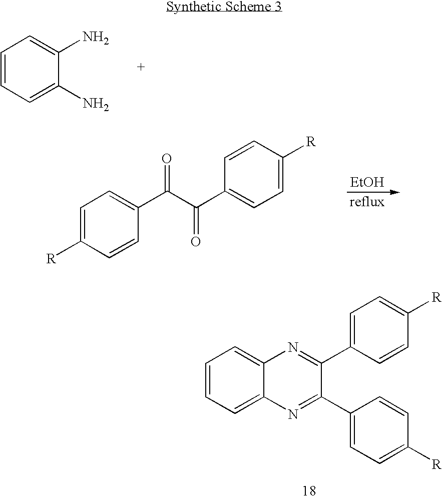
Synthesis of Cyclometalated μ-Chloro-Bridged Dimer

A cyclometalated μ-chloro-bridged dimer can be synthesized by reacting the quinoxaline derivative synthesized by the aforementioned method, and a metal halide such as iridium (III) chloride hydrate. (See Synthetic Scheme 4).

Synthesis of (1,3-dionato-κO,κO′) Organometallic Compound

A (1,3-dionato-κO,κO′) organometallic compound can be synthesized by reacting the cyclometalated μ-chloro-bridged dimer synthesized by the aforementioned method, and a 1,3-dicarbonyl compound such as 2,4-pentanedione (see Synthetic Scheme 4). 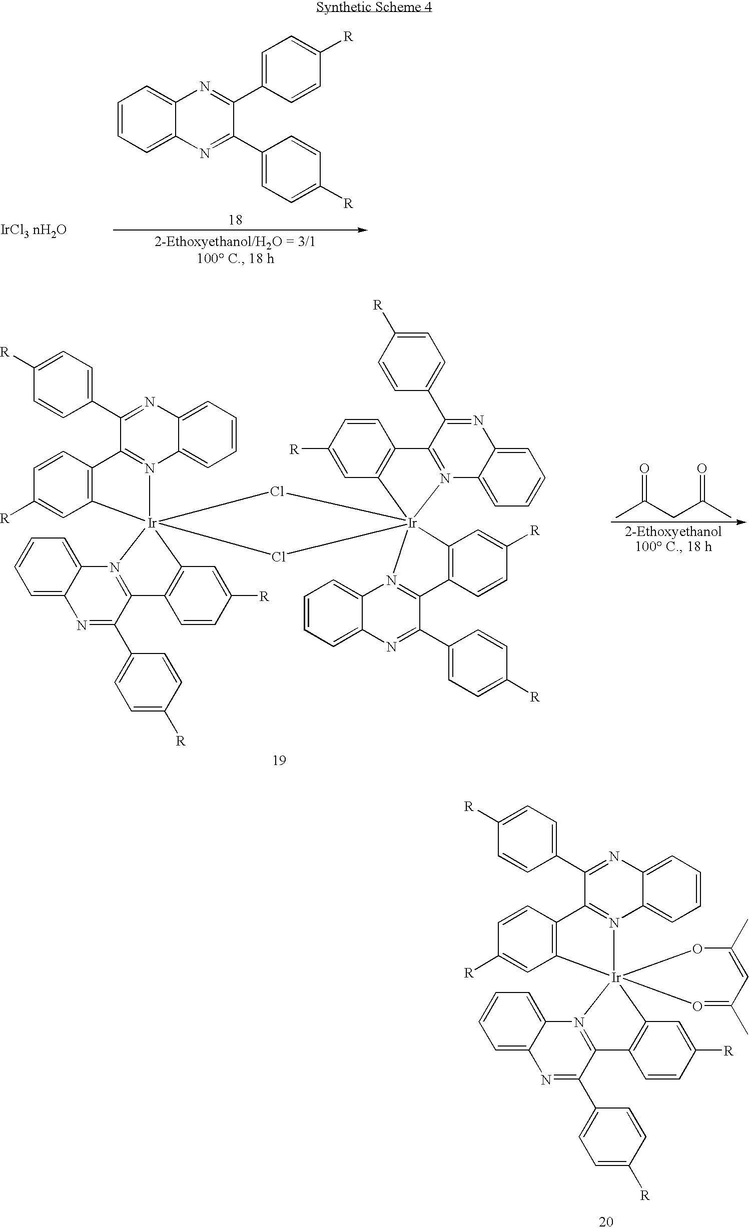
Synthesis of Tris-Type Organometallic Compound

As shown in Synthetic Scheme 5, a tris-type organometallic compound having a structure in which a (1,3-dionato-κO,κO′) site is substituted with a quinoxaline derivative, and three quinoxaline derivatives are bound to a metal can be synthesized by heating to react the (1,3-dionato-κO,κO′) organometallic compound synthesized by the aforementioned method, and a quinoxaline derivative in polar solvent such as glycerol having a high boiling point.

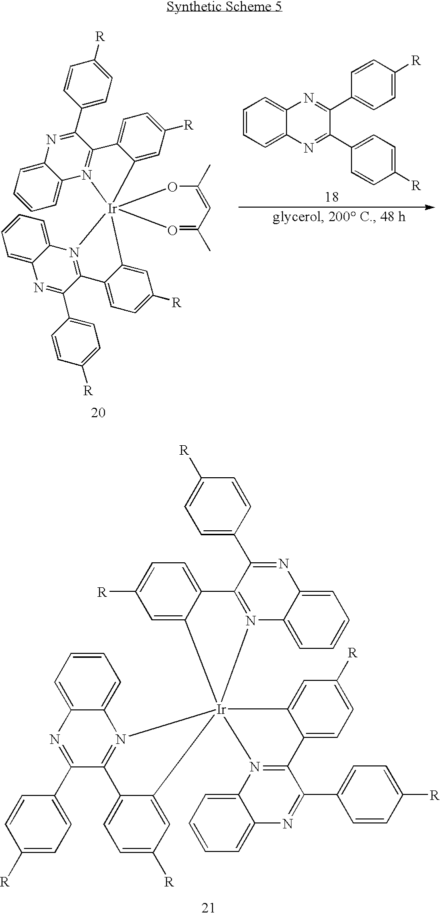

According to the present invention, an organometallic compound including a quinoxaline ring structure excellent in both of emitting color property and light emitting ef ficiency can be obtained. In addition, by using an organometallic compound having a quinoxaline structure in an emitting layer, an emitting element excellent in both of light emitting efficiency and emitting color property can be obtained.

### DESCRIPTION OF THE PREFERRED EMBODIMENTS

### Synthetic Example 1

### (i) Synthesis of 2,3-diphenylquinoxaline (quinoxaline derivative [18a])

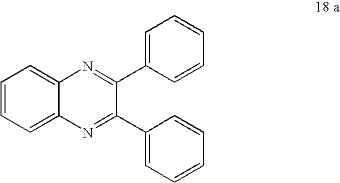

According to Synthetic Scheme 3, 1,2-phenylenediamine (2.428 g, 22.4 mmol) and benzil (4.721 g, 22.4 mmol) were heated to reflux for 24 hours in ethanol solvent (50 mL). After the reaction mixture was cooled to room temperature, 100 mL of water was added, the precipitates were filtered, the filtered solid was recrystallized from hot ethanol to obtain 2,3-diphenylquinoxaline [18a] (5.463 g, yield 86%) as a colorless needle crystal. This compound was analyzed, and the following results were obtained. m.p. 122° C.;

Infrared analysis result (KBr, cm⁻¹): 3056, 3027, 1540, 1442, 1348, 1226, 1142, 1076, 978, 929, 770, 731, 697, 598, 538;

¹H NMR (CDCl₃, 300 MHz): δ [ppm]: 7.32-7.38 (m, 6H) 7.51-7.54 (m, 4H), 7.78 (dd, J=3.4, 6.3 Hz, 2H), 8.19 (dd, J=3.4, 6.3 Hz, 2H);

¹³C NMR (CDCl₃, 75.5 MHz): δ [ppm]: 128.2, 128.7, 129.1, 129.7, 129.8, 138.9, 141.1, 153.3;

Theoretical value from elementary analysis for C₂₀H₁₄N₂: C, 85.11;H, 4.96;N, 9.93

Found; C, 84.83;H, 5.07;N, 9.90

### (ii) Synthesis of tetrakis(2,3-diphenylquinoxalyl-N,C²′) (μ-dichloro)diiridium(III)

### {cyclometalated μ-chloro-bridged dimer [19a]}

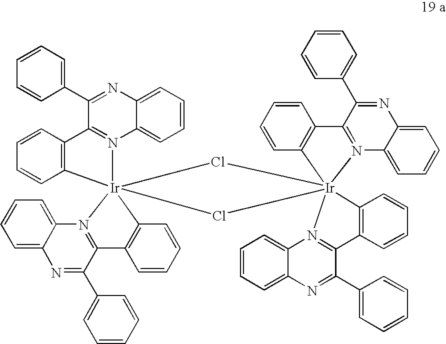

According to Synthetic Scheme 4, diphenylquinoxaline [18a] (5.647 g, 20.0 mmol) was added to 200 mL of a mixed solution of iridium chloride hydrate (2.986 g,10.0 mmol) in 2-ethoxyethanol/distilled water 3:1, and materials were heated at 100° C. for 18 hours. After the reaction mixture was cooled to room temperature, 100 mL of dichloromethane was added, aqueous layer was removed, the solvent was distilled off to obtain the residue, and 100 mL of ethanol and 50 mL of dichloromethane were added to the residue, allowed to stand for 12 hours, and precipitates were filtered to obtain the tetrakis (2,3-diphenylquinoxalyl-N,C²′) (μ-dichloro)diiridium(III) [19a] (6.283 g,yield 80%) as a brown solid. This compound was analyzed, and the following results were obtained. m.p.:higher than 300° C.;

Infrared analysis result (KBr,cm⁻¹): 3116, 3047, 2968, 2921, 2862, 1577, 1483, 1444, 1426, 1388, 1350, 1320, 1236, 1127, 1069, 805, 758, 697, 636;

¹H NMR (CDCl₃, 300 MHz): δ [ppm]: 5.66 (d, J=8.3 Hz, 1H) 6.18 (t, J=8.3 Hz, 1H), 6.45 (t, J=8.3 Hz, 1H), 6.70 (td, J=1.5, 8.3 Hz, 1H), 6.87 (t, J=8.3 Hz, 1H), 7.30 (d, J=8.3 Hz, 1H), 7.65-7.71 (m, 4H), 8.03-8.12 (br, 2H), 8.42 (d, J=8.3 Hz, 1H);

¹³C NMR(CDCl₃,75.5 MHz): δ [ppm]: 121.2, 126.3, 127.8, 128.1, 128.6, 128.8, 129.1, 129.7, 130.9, 134.8, 138.2, 139.9, 140.4, 146.5, 150.0, 151.9, 163.3;

Theoretical value from elementary analysis: C₈₀H₅₂Ir₂Cl₂N₈.H₂O: C, 60.10; H, 3.40; N, 7.01.

Found: C, 60.00; H, 3.51; N, 6.90.

### (iii) Synthesis of bis (2,3-diphenylquinoxalyl-N,C²′) (2,4-pentanedionato-κO, κO′) iridium

### {(1,3-dionato-κO, κO′) organometallic compound [20a]}

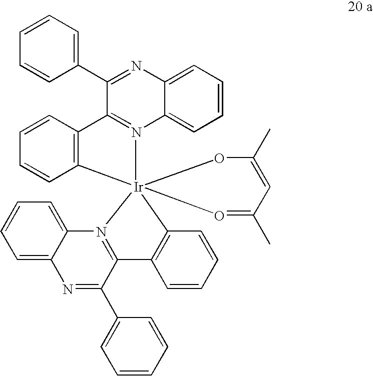

According to Synthetic Scheme 4, tetrakis(2,3-diphenylquinoxalyl-N,C²′) (μ-dichloro)diiridium (III) [19a] (108.0 mg,0.068 mmol),
2,4-pentanedione(20 μL,0.194 mmol) and sodium carbonate (206.4 mg,1.95 mmol) were heated and stirred in 5 mL of 2-ethoxyethanol at 100° C. for 18 hours. After the reaction mixture was cooled to room temperature, the reaction mixture was extracted with three portions of dichloromethane (100 mL)/water (50 mL), and the organic layer was dried with anhydrous magnesium sulfate. The solvent was distilled off, the resulting residue was purified by silica gel column chromatography (eluent:ethyl acetate), and the resulting solid was washed with 5 mL of ether to obtain
bis(2,3-diphenylquinoxalyl-N, C²′) (2,4-pentanedionate-κO′κO′) iridium[20a] (110.9 mg,yield 95%) as a brown solid. This compound was analyzed, and the following results were obtained. m.p.: higher than 300° C.;

Infrared analysis result (KBr, cm⁻¹): 3042, 2986, 2926, 2866, 1577, 1517, 1444, 1425, 1395, 1350, 1319, 1260, 1126, 1068, 1027, 807, 761, 733, 696, 637;

¹H NMR (CDCl₃, 300 MHz): δ [ppm]: 1.62 (s, 6H, CH₃), 4.69 (s, 1H, CH), 6.43 (dd, J=8.2, 1.5 Hz, 2H), 6.52 (td, J=8.2, 1.5 Hz, 2H), 6.61 (ddd, J=8.2, 7.2, 1.5 Hz, 2H), 7.08 (dd, J=8.2, 1.5 Hz, 2H), 7.50 (ddd, J=8.2, 7.2, 1.5 Hz, 2H), 7.61-7.68 (m, 8H), 8.00-8.05 (m, 4H), 8.12 (dd, J=8.2, 1.5 Hz, 2H), 8.42 (dd, J=8.2, 1.5 Hz, 2H);

¹³CNMR (CDCl₃, 75.5 MHz): δ [ppm]: 28.3 (CH₃), 99.9 (CH) 120.6, 125.8, 128.2, 128.7, 128.9, 129.0, 129.6, 130.0, 130.4, 130.8, 136.9, 139.7, 139.9, 141.5, 146.1, 153.2, 154.3, 163.5, 185.7 (CO);

Theoretical value from elementary analysis: C₄₅H₃₃IrN₄O₂.0.5C₆H₁₄: C, 64.27; H, 4.49; N, 6.25.

Found: C, 64.42; H, 4.50; N, 6.23.

A photoluminescence spectrum of this compound as a solution in dichloromethane at a concentration of 1.0×10⁻⁵ mole/liter was measured at a temperature of 298 K and, as a result, an emitting peak wavelength was 670 nm, and a photoluminescence quantum yield was 0.50.

As compared with the fact that a photoluminescence quantum yield of Ir(MDQ)₂(acac) disclosed in the document, Advanced Materials,2003,15(3),224-228 was 0.48, not only an emitting efficiency was improved about 4%, but also spectral property of light emission realized a red color closer to a ultimately pure primary color, according to the present invention.

### Synthetic Example 2

### (i) Synthesis of 2,3-bis(4-fluorophenyl)quinoxaline [18b]

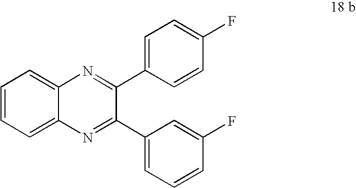

1,2-Phenylenediamine (1.214 g, 11.2 mmol) and 4,4′-difluorobenzyl (2.758 g, 11.2 mmol) were heated to reflux in ethanol solvent (50 mL) for 24 hours. After the reaction mixture was cooled to room temperature, 50 mL of water was added, precipitates were filtered, and the filtered solid was recrystallized from hot ethanol to obtain 2,3-bis(4-fluorophenyl)quinoxaline [18b] (3.421 g,yield 96%) as a colorless needle crystal. This compound was analyzed, and the following results were obtained. m.p.:132° C.;

Infrared analysis result (KBr, cm⁻¹): 3075, 3060, 1602, 1513, 1478, 1393, 1345, 1225, 1161, 1129, 1095, 1054, 1014, 980, 853, 840, 812, 764, 730, 664, 592, 543, 527;

¹H NMR (CDCl₃, 300 MHz): δ [ppm]: 7.06 (t, J=8.9 Hz, 2H), 7.51 (dd, J=8.9, 5.8 Hz, 2H), 7.79 (dd, J=6.4, 3.6 Hz, 2H), 8.16 (dd, J=6.4, 3.6 Hz, 2H);

¹³CNMR (CDCl₃, 75.5 MHz): δ [ppm]:115.5 (J_{13C-19F}=22 Hz), 129.0, 130.1, 131.7 (J_{13C-19F}=8.3 Hz), 134.8, 141.0, 152.0, 163.0 (J_{13C-19F}=249 Hz)

### (ii) Synthesis of tetrakis[2,3-bis(4-fluorophenyl)quinoxalyl-N,C²′](μ-dichloro)diiridium (III)

### {cyclometalated μ-chloro-bridged dimer [19b]}

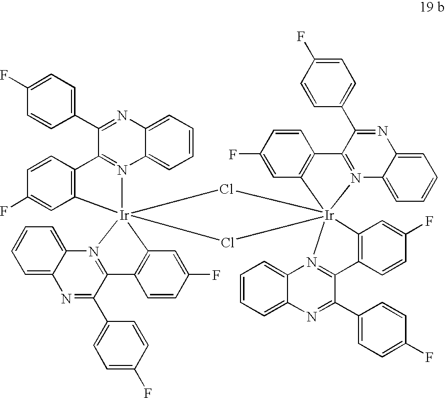

2,3-Bis(4-fluorophenyl)quinoxaline [18b](3.183 g, 10.0 mmol) was added to 100 mL of a solution of iridium chloride hydrate (1.493 g, 5.00 mmol) in 2-ethoxyethanol/distilled water (3:1), and the materials were heated at 100° C. for 18 hours. After the reaction mixture was cooled to room temperature, 100 mL of dichloromethane was added, the aqueous layer was removed, the solvent was distilled off to obtain the residue, 100 mL of ethanol was added to the residue, and allowed to stand for 12 hours, and the precipitates were filtered to obtain tetrakis[2,3-bis(4-fluorophenyl)quinoxalyl-N,C²′]μ-dichloro)diiridium (III) [19b](2.713 g,yield 63%) as an orange solid. This compound was analyzed, and the following results were obtained. m.p.: higher than 300° C.;

Infrared analysis result (KBr, cm⁻¹): 3120, 3060, 2968, 1871, 1584, 1560, 1507, 1484, 1457, 1387, 1353, 1313, 1259, 1234, 1195, 1158, 1126, 1096, 1066, 1015, 842, 802, 758, 733, 611, 566, 530, 521;

¹H NMR (CDCl₃, 300 MHz): δ [ppm]: 5.29 (dd, J=8.6, 2.3 Hz, 1H), 6.26 (ddd, J=8.6, 6.9, 2.3 Hz, 1H), 6.68 (ddd, J=8.6, 6.9, 2.3 Hz, 1H), 6.91 (dd, J=8.6, 5.7 Hz, 1H), 7.32 (ddd, J=8.6, 6.9, 1.1 Hz, 1H), 7.35-7.46 (br, 2H), 7.70 (dd, J=8.6, 1.1 Hz, 1H), 7.97-8.18 (br, 2H), 8.25 (d, J=8.6 Hz, 1H);

¹³CNMR (CDCl₃, 75.5 MHz): δ [ppm]: 109.8 (J_{13C-19F}=22 Hz), 115.9 (J_{13C-19F}=22 Hz), 117.0 (J_{13C-19F}=22 Hz), 120.7 (J_{13C-19F}=18 Hz) 125.6, 129.1 (J_{13C-19F}=4.3 Hz), 130.6 (J_{13C-19F}=7.7 Hz),131.0 (J_{13C-19F}=9.4 Hz),132.5 (J_{13C-19F}=8.3 Hz),135.6 (J_{13C-19F}=4.3 Hz), 138.2, 139.9, 142.3 (J_{13C-19F}=2.0 Hz), 150.5, 151.3 (J_{13C-19F}=7.5 Hz), 160.5 (J_{13C-19F}=240 Hz), 162.2, 163.9 (J_{13C-19F}=234 Hz);

Theoretical value from elementary analysis: C₈₀H₄₄Ir₂Cl₂F₈N₈.0.5CH₂Cl₂: C, 54.72; H, 2.57; N, 6.34.

Found: C, 54.66; H, 2.84; N, 6.30.

### (iii) Synthesis of bis[2,3-bis(4-fluorophenyl)quinoxalyl-N,C²′](2,4-pentanedio nato-κO,κO′)iridium

### {(1,3-dionato-κO,κO′) organometallic compound [20b]}

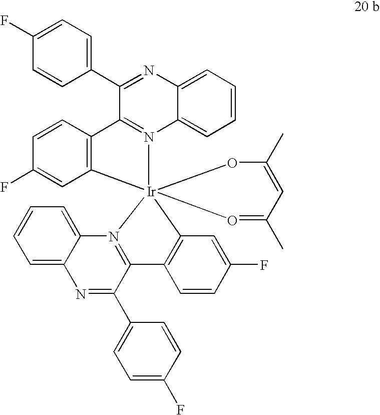

Tetrakis[2,3-bis(4-fluorophenyl)quinoxalyl-N,C²′](μ-d ichloro)diiridium (III) [19b](115.6 mg,0.068 mmol), 2,4-pentanedione (20 μL,0.194 mmol), and sodium carbonate (206.4 mg,1.95 mmol) were heated and stirred in 5 mL of 2-ethoxyethanol at 100° C. for 18 hours. After the reaction mixture was cooled to room temperature, the reaction mixture was extracted with three portions of dichloromethane (100 mL)/water (50 mL), and the organic layer was dried with anhydrous magnesium sulfate. The solvent was distilled off to obtain the residue, which was purified by silica gel column chromatography (eluent: ethyl acetate), and the resulting solid was washed with 5 mL of ether to obtain bis[2,3-bis(4-fluorophenyl)quinoxalyl-N,C²′](2,4-pentanedio nato-κO,κO′)iridium [20b](100.5 mg,yield79%) as a brown solid. This compound was analyzed, and the following results were obtained. m.p.: higher than 300° C.;

Infrared analysis result (KBr, cm⁻¹): 3065, 2959, 2921, 1581, 1560, 1508, 1389, 1354, 1311, 1236, 1190, 1158, 1124, 1065, 841, 805, 762, 734, 612, 523;

¹H NMR(CDCl₃,300 MHz): δ [ppm]: 1.63 (s, 6H, CH₃), 4.71 (s, 1H, CH), 6.05 (dd, J=9.1, 2.2 Hz, 2H), 6.39 (ddd, J=9.1, 6.8, 2.2 Hz, 2H), 7.09 (dd, J=9.1, 5.7 Hz, 2H), 7.30-7.35 (br, 4H), 7.53 (ddd, J=9.1, 6.8, 2.2 Hz, 2H), 7.68 (ddd, J=9.1, 6.8, 1.2 Hz, 2H), 8.00 (br, 8H), 8.11 (dd, J=6.8, 1.2 Hz, 2H), 8.20 (dd, J=6.8, 1.2 Hz, 2H);

¹³C NMR(CDCl₃, 75.5 MHz): δ [ppm]: 28.3 (CH₃), 100.2 (CH), 108.9 (J_{13C-19F}=23 Hz), 116.2 (J_{13C-19F}=23 Hz), 122.5 (J_{13C-19F}=18 Hz), 125.2, 129.2 (J_{13C-19F}=23 Hz), 130.7, 131.3, 131.8 (J_{13C-19F}=8.9 Hz), 135.7 (J_{13C-19F}=3.2 Hz), 139.7, 141.3, 142.0, 156.4 (J_{13C-19F}=7.2 Hz), 161.5 (J_{13C-19F}=271 Hz), 162.4, 163.6 (J_{13C-19F}=250 Hz), 185.8(CO);

Theoretical value from elementary analysis: C₄₅H₂₉IrF₄N₄O₂.0.5CH₂Cl₂: C, 56.43; H, 3.21; N, 5.79.

Found: C, 56.32; H, 3.09; N, 5.73.

A photoluminescence spectrum of this compound as a solution in dichloromethane at a concentration of 1.0×10⁻⁵ mole/liter was measured at a temperature of 298 K and, as a result, an emitting peak wavelength was 647 nm, and a photoluminescence quantum yield was 0.71.

As compared with a fact that an emitting peak wavelength of Ir(DBQ)₂ (acac) disclosed in the document, Advanced Materials, 2003,15(3),224-228 was 618 nm, and a photoluminescence quantum yield was 0.53, not only an emitting efficiency was considerably improved, but also spectral property of emission realized a red color closer to a ultimately pure primary color, according to the present invention.

### Synthetic Example 3

### (i) Synthesis of 2,3-bis(4-methylphenyl)quinoxaline [18c]

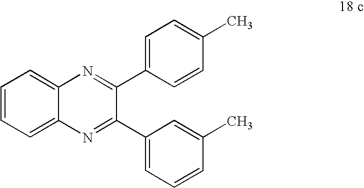

1,2-Phenylenediamine (2.163 g, 20.0 mmol) and 4,4′-dimethylbenzyl (4.766 g, 20.0 mmol) were heated to reflux in ethanol solvent (50 mL) for 24 hours. After the reaction mixture was cooled to room temperature, 100 mL of water was added, precipitates were filtered, and the filtrated solid was dried under reduced pressure at 100° C. for 4 hours to obtain 2,3-bis(4-methylphenyl)quinoxaline [18c](5.972 g, yield 96%) as a colorless needle crystal. This compound was analyzed, and the following results were obtained. m.p.:149° C.;

Infrared analysis result (KBr, cm⁻¹): 3030, 2969, 2913, 2863, 1612, 1556, 1514, 1475, 1409, 1394, 1344, 1308, 1280, 1249, 1223, 1213, 1186, 1142, 1110, 1056, 1020, 977, 965, 951, 832, 820, 761, 723, 607, 594, 546, 528;

¹H NMR (CDCl₃, 300 MHz): δ [ppm]: 2.37 (s, 3H, CH₃), 7.14 (d, J=7.8 Hz, 2H), 7.43 (d, J=7.8 Hz, 2H), 7.74 (dd, J=3.4, 6.4 Hz, 2H), 8.15 (dd, J=3.4, 6.4 Hz, 2H);

¹³C NMR (CDCl₃, 75.5 MHz): δ [ppm]: 21.5 (CH₃), 128.9, 129.0, 129.5, 129.6, 136.2, 138.6, 141.0, 153.3;

Theoretical value from elementary analysis: C₂₂H₁₈N₂: C, 85.13; H, 5.85; N, 9.03.

Found: C, 84.95; H, 5.93; N, 9.07.

### (ii) Synthesis of tetrakis[2,3-bis(4-methylphenyl)quinoxalyl-N,C²′](μ-dichloro)diiridium(III)

### {cyclometalated μ-chloro-bridged dimer [19c]}

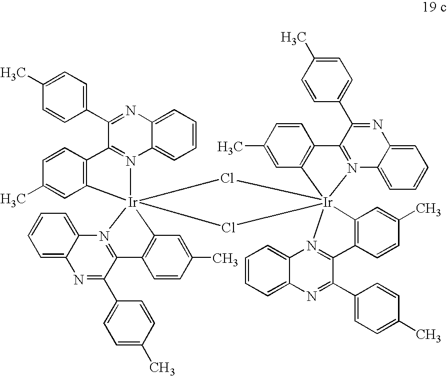

2,3-Bis(4-methylphenyl)quinoxaline [18c](3.104 g, 10.0 mmol) was added to 100 mL of a solution of iridium chloride hydrate (1.493 g, 5.00 mmol) in 2-ethoxyethanol/distilled water (3:1), and the materials were heated at 100° C. for 18 hours. After the reaction mixture was cooled to room temperature, 100 mL of dichloromethane was added, the aqueous layer was removed, the solvent was distilled off to obtain the residue, 100 mL of ethanol was added to the residue, and allowed to stand for 12 hours, and precipitates were filtered to obtain tetrakis[2,3-bis(4-methylphenyl)quinoxalyl-N, C²′](μ-dichloro)diiridium(III) [19c](3.572 g,yield 84%) as a brown solid. This compound was analyzed, and the following results were obtained. m.p.: higher than 300° C.;

Infrared analysis result (KBr, cm⁻¹): 3026, 2950, 2918, 2857, 1586, 1509, 1483, 1457, 1388, 1353, 1317, 1235, 1209, 1183, 1140, 1073, 1042, 1020, 980, 828, 809, 756, 730, 613, 512;

¹H NMR (CDCl₃, 300 MHz): δ [ppm]: 2.57 (s, 3H, CH₃), 5.47 (d, J=1.3 Hz, 1H), 6.28 (dd, J=8.4, 1.3 Hz, 1H), 6.65 (ddd, J=8.4, 6.9, 1.3 Hz, 1H), 6.79 (d, J=8.4 Hz, 1H), 7.24(ddd, J=8.4, 6.9, 1.3 Hz, 1H), 7.42-7.57 (br, 2H), 7.65 (dd, J=8.4, 1.3 Hz, 1H), 7.88-8.03 (br, 2H), 8.35 (d, J=8.4 Hz, 1H)

¹³CNMR (CDCl₃, 75.5 MHz): δ [ppm]:21.2 (CH₃), 21.8 (CH₃), 122.3, 126.4, 128.3, 128.5, 128.7, 128.9, 129.6, 135.4, 137.3, 137.9, 138.0, 139.5, 140.3, 143.9, 150.5, 151.8, 163.3.

### (iii) Synthesis of bis[2,3-bis(4-methylphenyl)quinoxalyl-N, C²′](2,4-pentanedio nato-κO,κO′)iridium

### {(1,3-dionato-κO,κO′) organometallic compound [20c]}

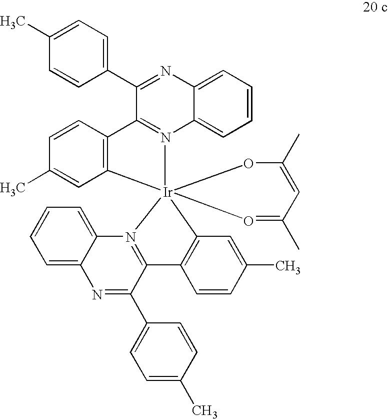

Tetrakis[2,3-bis(4-methylphenyl)quinoxalyl-N,C²′](μ-dichloro)diiridium (III) [19c](115.6 mg,0.068 mmol), 2,4-pentanedione (20 μL,0.194 mmol) and sodium carbonate (206.4 mg,1.95 mmol) were heated and stirred in 5 mL of 2-ethoxyethanol at 100° C. for 18 hours. After the reaction mixture was cooled to room temperature, the reaction mixture was extracted with three portions of dichloromethane (100 mL)/water (50 mL), and the organic layer was dried with anhydrous magnesium sulfate. The solvent was distilled off to obtain the residue, the residue was purified by silica gel column chromatography (eluent: ethyl acetate), and the resulting solid was washed with 5 mL of ether to obtain bis[2,3-bis(4-methylphenyl)quinoxalyl-N,C²′](2,4-pentanedio nato-κO,κO′)iridium [20c](39.6 mg,yield 32%) as a brow solid. This compound was analyzed, and the following results were obtained. m.p.: higher than 300° C.;

Infrared analysis result (KBr, cm⁻¹): 3028, 2927, 2857, 1583, 1560, 1522, 1391, 1352, 1316, 1261, 1183, 1140, 1072, 810, 767, 732, 612, 513;

¹H NMR (CDCl₃, 300 MHz): δ[ppm]: 1.59 (s, 6H, CH₃), 2.51 (s, 6H, CH₃), 4.67 (s, 1H, CH), 6.28 (d, J=1.1 Hz, 2H), 6.46 (dd, J=8.6, 1.7 Hz, 2H), 7.05 (d, J=8.6 Hz, 2H), 7.40-7.59 (m, 6H), 7.61 (ddd, J=8.6, 6.8, 1.1 Hz, 2H), 7.90-7.93 (br, 2H), 8.09 (dd, J=8.6, 1.7 Hz, 2H), 8.21 (d, J=8.6 Hz, 2H);

¹³CNMR (CDCl₃, 75.5 MHz): δ [ppm]: 21.5 (CH₃), 21.7 (CH₃), 28.3 (CH₃), 99.9 (CH), 121.9, 125.7, 128.6, 128.7, 129.6, 129.8, 130.0, 137.3, 137.5, 138.4, 139.5, 139.6, 141.5, 143.5, 153.2, 154.6, 163.5, 185.5 (CO).

A photoluminescence spectrum of this compound as a solution in dichloromethane at a concentration of 1.0×10⁻⁵ mole/liter was measured at a temperature of 298 K and, as a result, an emitting peak wavelength was 669 nm, and a photoluminescence quantum yield was 0.79.

As compared with the fact that an emitting peak wavelength of Ir(DBQ)₂(acac) disclosed in the document, Advanced Materials, 2003,15(3),224-228 was 618 nm, and a photoluminescence quantum yield was 0.53, not only an emitting efficiency was considerably improved, but also spectral property of light emission realized a red color closer to a ultimately pure primary color, according to the present invention.

### Synthetic Example 4

### (i) Synthesis of 2,3-bis(4-methoxyphenyl)quinoxaline [18d]

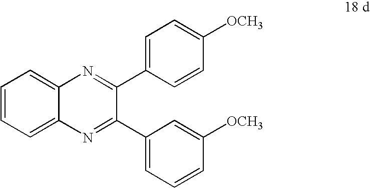

1,2-Phenylenediamine (2.163 g, 20.0 mmol) and 4,4′-dimethoxybenzyl (5.406 g, 20.0 mmol) were heated to reflux in ethanol solvent (50 mL) for 24 hours. After the reaction mixture was cooled to room temperature, 100 mL of water was added, precipitates were filtered, and the filtered solid was recrystallized from hot ethanol to obtain 2,3-bis(4-methoxyphenyl)quinoxaline [18d](6.121 g,yield 89%) as a colorless needle crystal. This compound was analyzed, and the following results were obtained. m.p.:148° C.;

Infrared analysis result (KBr, cm⁻¹): 3062, 3005, 2960, 2935, 2838, 1607, 1577, 1513, 1477, 1458, 1394, 1347, 1288, 1244, 1171, 1139, 1112, 1059, 1028, 977, 830, 780, 765, 734, 660, 596, 546;

¹H NMR (CDCl₃, 300 MHz): δ [ppm]:3.84 (s, 3H, CH₃O), 6.87 (d, J=9.0 Hz, 2H), 7.49 (d, J=9.0 Hz, 2H), 7.73 (dd, J=3.4, 6.4 Hz, 2H), 8.13 (dd, J=3.4, 6.4 Hz, 2H);

¹³C NMR (CDCl₃, 75.5 MHz): δ [ppm]: 55.3 (CH₃O), 113.7, 128.9, 129.4, 131.1, 131.5, 140.9, 152.9, 159.9;

Theoretical value from elementary analysis: C₂₂H₁₈N₂O₂: C, 77.17; H, 5.30; N, 8.18.

Found: C, 77.02; H, 5.28; N, 8.19.

### (ii) Synthesis of tetrakis[2,3-bis(4-methoxyphenyl)quinoxalyl-N,C²′](μ-dichloro)diiridium(III)

### {cyclometalated μ-chloro-bridged dimer [19d]}

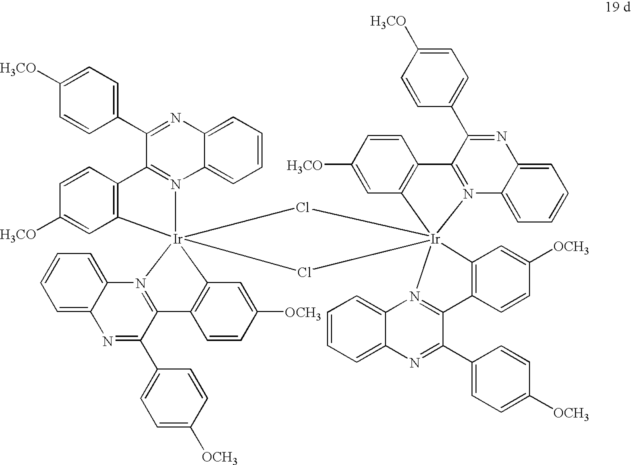

2,3-Bis(4-methoxyphenyl)quinoxaline [18d] (0.685 g, 2.00 mmol) was added to 20 mL of a solution of iridium chloride hydrate (0.299 g, 1.00 mmol) in 2-ethoxyethanol/distilled water (3:1), and the materials were heated at 100° C. for 18 hours. After the reaction mixture was cooled to room temperature, 100 mL of dichloromethane was added, the aqueous layer was removed, the solvent was distilled off to obtain the residue, 100 mL of ethanol was added to the residue, and allowed to stand 12 hours, and precipitates were filtered to obtain tetrakis[2,3-bis(4-methoxyphenyl)quinoxalyl-N,C²′](μ-dichloro)diiridium (III) [19d](0.748 g,yiled 82%) as a red solid. This compound was analyzed, and the following results were obtained. m.p.: higher than 300° C.;

Infrared analysis result (KBr, cm⁻¹): 3070, 2932, 2834, 1606, 1580, 1507, 1457, 1384, 1353, 1302, 1254, 1222, 1174, 1132, 1031, 837, 758, 615, 548;

¹H NMR(CDCl₃, 300 MHz): δ [ppm]: 3.99 (s, 3H, CH₃O), 5.21 (d, J=2.6 Hz, 1H), 6.07 (dd, J=8.7, 2.6 Hz, 1H), 6.65 (dd, J=8.7, 7.5 Hz, 1H), 6.91 (d, J=8.7 Hz, 1H), 7.20 (dd, J=8.7, 7.5 Hz, 1H), 7.21-7.26 (br, 2H), 7.60 (d, J=8.7 Hz, 1H) 7.98-8.08 (br, 2H), 8.41 (d, J=8.7 Hz, 1H);

¹³C NMR (CDCl₃, 75.5 MHz): δ [ppm]: 54.3 (CH₃O), 55.5 (CH₃O), 109.0, 113.7, 115.1, 118.3, 126.3, 127.8, 128.5, 129.5, 130.5, 132.6, 137.9, 139.3, 140.0, 151.2, 152.7, 158.1, 160.7, 163.0;

Theoretical value from elementary analysis: C₈₈H₆₈Ir₂Cl₂N₈O₈.H₂O: C, 57.48; H, 3.84; N, 6.09.

Found: C, 57.44; H, 3.91; N, 5.95.

### (iii) Synthesis of bis[2,3-bis(4-methoxyphenyl)quinoxalyl-N,C2′](2,4-pentanedionato-κO,κO′)iridium

### {(1,3-dionato-κO,κO′) organometallic compound [20d]}

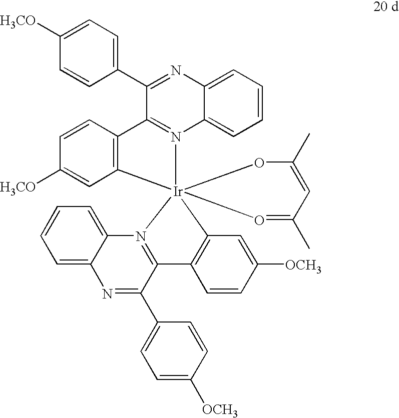

Tetrakis[2,3-bis(4-methoxyphenyl)quinoxalyl-N,C²′](μ-dichloro)diiridium (III) [19d](124.4 mg,0.068 mmol), 2,4-pentanedione (20 μL,0.194 mmol) and sodium carbonate (206.4 mg,1.95 mmol) were heated and stirred in 5 mL of 2-ethoxyethanol at 100° C. for 18 hours. After the reaction mixture was cooled to room temperature, the reaction mixture was extracted with three portions of dichloromethane (100 mL)/water (50 mL), and the organic layer was dried with anhydrous magnesium sulfate. The solvent was distilled off to obtain the residue, which was purified by silica gel column chromatography (eluent: ethyl acetate), and the resulting solid was washed with 5 mL of ether to obtain [2,3-bis(4-methoxyphenyl)quinoxalyl-N,C²′](2,4-pentanedionato-κO,κO′)iridium [20c](75.0 mg,yield 56w) as a brown solid. This compound was analyzed, and the following results were obtained. m.p.: higher than 300° C.;

Infrared analysis result (KBr, cm⁻¹): 3065, 2959, 2922, 2833, 1580, 1560, 1518, 1507, 1457, 1437, 1395, 1303, 1257, 1222, 1175, 1131, 1031, 838, 765, 614;

¹H NMR (CDCl₃, 300 MHz): δ [ppm]: 1.61 (s, 6H, CH₃), 3.94 (s, 6H, CH₃O), 4.70 (s, 1H, CH), 5.93 (d, J=2.7 Hz, 2H), 6.24 (dd, J=8.6, 2.7 Hz, 2H), 7.11 (d, J=8.6 Hz, 2H), 7.11-7.13 (m, 4H), 7.45 (ddd, J=8.6, 6.8, 1.1 Hz, 2H), 7.57 (ddd, J=8.6, 6.8, 1.1 Hz, 2H), 7.95-7.99 (br, 2H), 8.05 (dd, J=8.6, 1.7 Hz, 2H), 8.23 (d, J=8.6 Hz, 2H);

¹³CNMR (CDCl₃, 75.5 MHz): δ [ppm]:28.3 (CH₃), 54.7 (CH₃O) 55.5 (CH₃O), 100.0 (CH), 107.6, 114.4, 120.9, 125.5, 128.2, 128.7, 129.8, 130.7, 131.5, 132.6, 139.1, 139.4, 141.3, 152.6, 156.7, 158.7, 160.6, 163.2, 185.5;

Theoretical value from elementary analysis: C₄₉H₄,IrN₄O₆: C, 60.42; H, 4.24; N, 5.75.

Found: C, 60.13; H, 4.41; N, 5.60.

A photoluminescence spectrum of this compound as a solution in dichloromethane at a concentration of 1.0×10⁻⁵ mole/liter was measured at a temperature of 298 K and, as a result, an emitting peak wavelength was 659 nm, and a photoluminescence quantum yield was 0.67.

As compared with the fact that an emitting peak wavelength of Ir (DBQ)₂ (acac) disclosed in the document, Advanced Materials, 2003,15(3),224-228 was 618 nm, and a photoluminescence quantum yield was 0.53, not only an emitting efficiency was considerably improved, but also emitting spectral property realized a red color closer to a ultimately pure primary color, according to the present invention.

Yields of compounds 18a and 18d, 19a to 19d and 20a to 20d are summarized in Table 1 and Table 2.

TABLE 1

| R | Yield [%] | R | Yield [%] |
|---|---|---|---|
| H | 86% (18a) | CH₃ | 96% (18c) |
| F | 96% (18b) | CH₃O | 89% (18d) |

TABLE 2

| | |
|---|---|
| R | Yield [%] |

| | | |
|---|---|---|
| H | 80% (19a) | 95% (20a) |
| F | 63% (19b) | 79% (20b) |
| CH₃ | 84% (19c) | 32% (20c) |
| CH₃O | 82% (19d) | 56% (20d) |

Summary of Results from Measurement of Optical Properties of Quinoxaline Derivative

Regarding a quinoxaline derivative and a (1,3-dionato-κO,κO′) organometallic compound, ultraviolet and visible absorption and a photoluminescence spectrum were measured, and the results are shown in Table 3. In an ultraviolet and visible absorption spectrum, absorption was observed at 200 to 300 nm, 330 nm and 360 nm in a quinoxaline derivative, respectively. In the (1,3-dionato-κO, κO′) organometallic compound, in addition to these absorptions, new absorption was observed at 470 to 480 nm.

A photoluminescence spectrum of the (1,3-dionato-κO, κO′) organometallic compound was measured and, as a result, red emission of an extremely high color purity having an emitting peak wavelength at 647 to 670 nm was exhibited (excitation wavelength is 380 to 400 nm). A photoluminescence quantum yield was shown to be an extremely better value of 0.50 to 0.79.

TABLE 3

| | | Excitation | Emitting | |
|---|---|---|---|---|
| | Ultraviolet and Visible Absorption Spectrum | Wavelength | Wavelength | Quantum |
| No. | λₘₐₓ (nm) (log ε)^{a} | λₘₐₓ (nm)^{a} | λₘₐₓ (nm)^{a} | Yield |
| 18a | 229 (5.13), 260 (4.83), 279 (4.76), 324 (4.65), 356 (4.05) | 292 | 345 | |
| 18b | 231 (5.39), 259 (5.03), 279 (4.96), 304 (4.79), 324 (4.70), | 295 | 345 | |
| | 356 (4.12) | | | |
| 18c | 232 (5.47), 261 (5.10), 306 (4.76), 322 (4.53), 357 (4.11) | 296 | 345 | |
| 18d | 236 (5.48), 279 (5.15), 305 (4.90), 322 (4.63), 363 (4.23) | 295 | 344 | |
| 20a | 233 (5.43), 257 (5.15), 281 (5.11), 306 (4.93), 325 (4.79), | 379 | 670 | 0.50 |
| | 378 (4.41), 480 (3.93) | | | |
| 20b | 232 (5.37), 257 (5.08), 279 (5.03), 304 (4.91), 322 (4.79), | 377 | 647 | 0.71 |
| | 360 (4.35), 471 (3.99) | | | |
| 20c | 232 (5.36), 254 (5.15), 280 (5.03), 380 (4.53), 477 (4.07) | 383 | 669 | 0.79 |
| 20d | 230 (5.27), 262 (5.05), 287 (4.90), 389 (4.31), 414 (4.35), | 418 | 659 | 0.67 |
| | 477 (4.04) | | | |

^{a}1.0 × 10⁻⁵ M in CH₂Cl₂solution at 298 K

### Synthetic Example 5

Synthesis of symmetric-type 2,3-disubstituted quinoxaline derivative (see Synthetic Scheme 1, Table 4 and Table 6)

A flask was replaced with an argon atmosphere, toluene (5 mL), ethanol (0.7 mL), and an aqueous K₂CO₃ solution (2. Om:2.2 mL) were injected into the flask with a syringe through a rubber septum, and 2,3-dichloroquinoxaline (199.0 mg, 1.0 mmol), a boronic acid derivative (2.2 mmol) corresponding to a structure of an intended quinoxaline derivative, and Pd (PPh₃)₄ (69.3 mg, 6 mol %) which acts as a coupling catalyst were reacted for 48 hours by heating and stirring in the refluxing state. After allowing to cool, a small amount of dichloromethane was added, and transferred to a separatory funnel. The organic layer was separated, the aqueous layer was extracted with dichloromethane two times, the extracted organic layers were all mixed, washed with water, and dried with anhydrous MgSO₄, and MgSO₄ was removed by filtration. The solvent was distilled off to obtain the residue, which was purified by silica gel column chromatography (eluent is a mixed solvent of ethyl acetate: n-hexane at a volume ratio of 1:10) to obtain an intended quinoxaline derivative. The quinoxaline derivative was analyzed, and the following results were obtained.

2,3-Bis(2-methylphenyl)quinoxaline {quinoxaline derivative (1d)}

White solid; m.p.:132 to 133° C.;

¹H NMR (CDCl₃, 300 MHz): δ [ppm]: 8.20 (dd, J=6.5, 3.5 Hz, 2H), 7.82 (dd, J=6.3, 3.6 Hz, 2H), 7.16-7.24 (m, 4H), 7.04-7.13 (m, 4H), 2.21 (s, 6H);

¹³C NMR (CDCl₃, 75.5 MHz): δ [ppm]: 154.9, 140.8, 137.9, 136.1, 130.4, 129.90, 129.87, 129.1, 128.4, 125.2, 20.0;

Infrared analysis result (KBr, cm⁻¹): 3057, 3023, 2924, 1603, 1559, 1493, 1477, 1455, 1376, 1341, 1324, 1213, 1129, 1055, 1032, 976, 871, 818, 784, 763, 746, 732, 606, 588, 567;

Results of EIMS mass spectroscopy m/z: 310 (M⁺);

Theoretical value from elementary analysis C₂₂H₁₈N₂: C, 85.13; H, 5.85; N, 9.03.

Found: C, 84.84; H, 5.87; N, 8.94.

2,3-Bis(2-trifluoromethylphenyl)quinoxaline (if) White solid; m.p.:140 to 141° C.;

¹H NMR (CDCl₃, 300 MHz): δ[ppm]:8.20 (dd, J=6.5, 3.5 Hz, 2H), 7.86 (dd, J=6.5, 3.5 Hz, 2H), 7.76 (dd, J=8.0, 0.8 Hz, 2H), 7.34-7.46 (m, 4H), 7.20 (d, J=7.5 Hz, 2H);

¹³C NMR (CDCl₃, 75.5 MHz): δ [ppm]: 131.1, 130.7, 129.3, 129.0, 128.7, 127.0, 126.9, 125.8, 122.1;

Infrared analysis result (KBr, cm⁻¹): 3068, 1977, 1952, 1843, 1725, 1647, 1606, 1579, 1560, 1479, 1446, 1346, 1308, 1270, 1146, 1065, 1033, 979, 961, 809, 771, 693, 648, 612, 584, 573;

Results of EIMS mass spectroscopy m/z: 418 (M⁺);

Theoretical value from elementary analysis C₂₂H₁₂F₆N₂: C, 63.16; H, 2.89; N, 6.70.

Found: C, 63.15; H, 2.91; N, 6.63.

2,3-Bis(1-naphthyl) quinoxaline [1 g]

White solid; m.p.: 208 to 209° C.;

¹H NMR (CDCl₃, 300 MHz): δ [ppm]:8.31 (dd, J=6.5, 3.5 Hz, 2H), 7.86-7.93 (m, 4H), 7.77 (d, J=7.5 Hz, 2H), 7.69 (d, J=7.8 Hz, 2H), 7.32-7.44 (m, 4H), 7.12-7.24 (m, 4H);

¹³C NMR (CDCl₃, 75.5 MHz) δ [ppm]: 150.5, 136.6, 131.3, 129.0, 127.1, 125.9, 124.9, 124.4, 123.8, 123.2, 121.9, 121.3, 120.9, 120.1;

Infrared analysis result (KBr, cm⁻¹): 3057, 1943, 1824, 1592, 1559, 1535, 1507, 1475, 1318, 1248, 1176, 1113, 973, 947, 865, 801, 766, 657, 610, 563, 538;

Results of EIMS mass spectroscopy m/z: 382 (M⁺);

Theoretical value from elementary analysis C₂₈H₁₈N₂: C, 87.93; H, 4.74; N, 7.32.

Found: C, 87.66; H, 4.82; N, 7.30.

### Synthetic Example 6

Synthesis of asymmetric-type-2,3-disubstituted quinoxaline derivative (see Synthetic Scheme 2, Table 5 and Table 6)

A flask was replaced with an argon atmosphere, 5 mL of dioxane was injected into the flask with a syringe, and 2,3-dichloroquinoxaline (398.1 mg,2.0 mmol), a first boronic acid derivative Ar¹B(OH)₂ (2.2 mmol) corresponding to a structure of an intended quinoxaline derivative, Pd₂(dba)₃ (27.5 mg,1.5 mol %) which acts as a coupling catalyst, tricyclohexylphosphine [abbreviated as Cy3P](20.2 mg,3.6 mol %) and Cs₂CO₃ (1303.3 mg,4.6 mmol) were heated and stirred at 85° C. for 24 hours. After allowed to cool to room temperature, a small amount of dichloromethane was added, and this was filtered with Celite. The solvent was distilled off to obtain the residue, which was purified by silica gel column chromatography to obtain an intended monohalogenated quinoxaline derivative group 2.

The flask was replaced with an argon atmosphere, toluene (2.5 mL), ethanol (0.35 mL), and K₂CO₃ (1.1 mL as 2.0 mole/liter of aqueous solution) were injected into the flask with a syringe through a rubber septum, and the monohalogenated quinoxaline derivative group 2 (1.0 mmol), a second boronic acid derivative Ar²B(OH)₂ (1.1 mmol) corresponding to a structure of an intended asymmetric-type-2,3-disubstituted quinoxaline derivative, and Pd(PPh₃)₄ (34.7 mg, 3.0 mol %) which acts as a coupling catalyst were heated and stirred for 48 hours in the refluxing state. After allowing to cool, a small amount of dichloromethane was added, and this was transferred to a separatory funnel. The organic layer was separated, the aqueous layer was extracted with dichloromethane two times, all of the extracted organic layers were mixed, washed with water, dried with anhydrous MgSO₄, and MgSO₄ was removed by filtration. The solvent was distilled off to obtain the residue, which was purified by silica gel column chromatography (eluent is a mixed solvent of ethyl acetate: n-hexane at a volume ratio of 1:10) to obtain an intended quinoxaline derivative.

The quinoxaline derivative was analyzed, and the following results were obtained.

2-Chloro-3-(2-methylphenyl)quinoxaline (2b)

White solid; m.p.:119 to 120° C.;

¹H NMR (CDCl₃, 300 MHz): δ [ppm]: 8.14-8.17 (m, 1H), 8.08-8.12 (m, 1H), 7.79-7.86 (m, 2H), 7.40-7.45 (m, 2H), 7.34-7.38 (m, 2H), 2.23 (s, 3H);

¹³C NMR (CDCl₃, 75.5 MHz): δ [ppm]: 154.3, 153.0, 147.2, 141.2, 140.6, 136.6, 136.2, 130.8, 130.3, 129.4, 129.1, 128.8, 128.1, 125.8, 19.7;

Infrared analysis result (KBr, cm⁻¹): 3061, 3034, 1684, 1653, 1559, 1539, 1482, 1456, 1331, 1293, 1276, 1153, 1130, 1086, 981, 775, 760, 723, 601;

Results of EIMS mass spectroscopy m/z: 254 (M⁺);

Theoretical value from elementary analysis C₁₅H₁₁ClN₂: C, 70.73; H, 4.35; N, 11.00; Cl, 13.92.

Found: C, 70.58; H, 4.39; N, 11.00; Cl, 13.80.

2-Chloro-3-(2-methoxyphenyl)quinoxaline (2c)

White solid; m.p.:134 to 135° C.;

¹H NMR (CDCl₃, 300 MHz): δ [ppm]: 8.13-8.18 (m, 1H), 8.05-8.10 (m, 1H), 7.75-7.82 (m, 2H), 7.42-7.53 (m, 2H), 7.10-7.16 (m, 1H), 7.04 (dd, J=8.3, 0.8 Hz, 1H), 3.82 (s, 3H)

¹³C NMR (CDCl₃, 75.5 MHz): δ [ppm]: 157.1, 152.5, 148.0, 141.0, 140.8, 139.7, 131.1, 130.6, 130.1, 130.0, 129.1, 128.1, 120.8, 111.0, 55.6;

Infrared analysis result (KBr, cm⁻¹): 3033, 2828, 1601, 1585, 1559, 1495, 1465, 1433, 1386, 1335, 1303, 1269, 1251, 1118, 1089, 1047, 1027, 983, 935, 849, 771, 755, 687, 601, 544;

Results of EIMS mass spectroscopy m/z: 270 (M⁺);

Theoretical value from elementary analysis C₁₅H₁₁ClN₂O: C, 66.55; H, 4.10; N, 10.35; Cl, 13.10.

Found: C, 66.44; H, 4.19; N, 10.30; Cl, 12.88.

2-(2-Methylphenyl)-3-phenylquinoxaline [3c]

White solid; m.p.:109 to 110° C.;

¹H NMR (CDCl₃, 300 MHz): 8.16-8.24 (m, 2H), 7.78-7.82 (m, 2H), 7.48-7.52 (m, 2H), 7.15-7.34 (m, 7H), 2.01 (s, 3H);

¹³C NMR (CDCl₃, 75.5 MHz): δ [ppm]: 154.3, 153.5, 141.4, 140.8, 138.8, 138.4, 135.8, 130.4, 129.91, 129.86, 129.79, 129.5, 129.2, 129.1, 128.72, 128.64, 127.9, 125.9, 19.8;

Infrared analysis result (KBr, cm⁻¹): 3056, 3022, 2925, 1602, 1559, 1544, 1495, 1478, 1457, 1442, 1394, 1379, 1345, 1247, 1219, 1129, 1077, 1056, 1026, 977, 924, 764, 725, 695, 603, 565, 553;

Results of EIMS mass spectroscopy m/z: 296 (M⁺);

Theoretical value from elementary analysis C₂₁H₁₆N₂: C, 85.11; H, 5.44; N, 9.45.

Found: C, 85.14; H, 5.60; N, 9.40. 2-(2-Methylphenyl)-3-(4-methylphenyl)quinoxaline [3d]:

White solid; m.p.:121 to 122° C.;

¹H NMR (CDCl₃, 300 MHz): δ [ppm]: 8.15-8.22 (m, 2H) 7.76-7.80 (m, 2H), 7.16-7.41 (m, 6H), 7.08 (d, J=8.4 Hz, 2H), 2.33 (s, 3H), 2.01 (s, 3H);

¹³C NMR(CDCl₃, 75.5 MHz): δ [ppm]: 154.3, 153.5, 141.4, 140.7, 139.1, 138.8, 135.8, 135.6, 130.4, 129.81, 129.80, 129.6, 129.4, 129.1, 129.0, 128.7, 128.6, 125.9, 21.4, 19.8;

Infrared analysis result (KBr, cm⁻¹): 3060, 3018, 2960, 2924, 1614, 1557, 1539, 1513, 1476, 1457, 1392, 1381, 1342, 1248, 1213, 1184, 1127, 1056, 1039, 1021, 978, 847, 832, 805, 767, 728, 601, 555, 509, 463;

Results of EIMS mass spectroscopy m/z: 310 (M⁺);

Theoretical value from elementary analysis C₂₂H₁₈N₂: C, 85.13; H, 5.85; N, 9.03.

Found: C, 84.93; H, 6.04; N, 8.86.

2-(4-Methoxyphenyl)-3-(2-methylphenyl)quinoxaline (3e)

White solid; m.p.: 104 to 105° C.;

¹H NMR (CDCl₃, 300 MHz): δ [ppm]: 8.13-8.20 (m, 2H) 7.75-7.80 (m, 2H), 7.44-7.47 (m, 2H), 7.17-7.37 (m, 4H), 6.78-6.81 (m, 2H), 3.79 (s, 3H), 2.00 (s, 3H);

¹³C NMR(CDCl₃, 75.5 MHz): δ [ppm]: 160.1, 154.2, 153.0, 141.5, 140.6, 139.2, 135.7, 130.9, 130.8, 130.4, 129.81, 129.75, 129.4, 129.04, 129.01, 128.6, 126.0, 113.5, 55.3, 19.7;

Infrared analysis result (KBr, cm⁻¹): 3060, 3000, 2934, 2837, 1603, 1577, 1513, 1476, 1457, 1392, 1341, 1294, 1250, 1174, 1143, 1028, 976, 838, 809, 768, 730, 646, 600, 557, 544;

Results of EIMS mass spectroscopy m/z: 326 (M⁺);

Theoretical value from elementary analysis C₂₂H₁₈N₂O: C, 80.96; H, 5.56; N, 8.58.

Found: C, 80.87; H, 5.70; N, 8.45.

2-(2-Methoxyphenyl)-3-(2-methylphenyl)quinoxaline [3f]

White solid; m.p.: 122 to 123° C.;

¹H NMR (CDCl₃, 300 MHz): δ [ppm]: 8.16-8.23 (m, 2H) 7.76-7.81 (m, 2H), 7.54 (dd, J=7.5, 1.5 Hz, 1H), 7.26-7.33 (m, 1H), 7.16-7.18 (m, 2H), 7.00-7.07 (m, 3H), 6.65 (d, J=8.4 Hz, 1H), 3.36 (s, 3H), 2.26 (s, 3H);

¹³C NMR (CDCl₃, 75.5 MHz): δ [ppm]: 156.2, 155.6, 153.2, 141.1, 140.8, 138.3, 136.4, 131.0, 130.4, 130.1, 129.6, 129.5, 129.3, 129.2, 129.1, 128.2, 128.0, 124.5, 120.7, 110.4, 54.6, 20.0;

Infrared analysis result (KBr, cm⁻¹): 3068, 3007, 2965, 2934, 2834, 1600, 1582, 1559, 1493, 1477, 1461, 1433, 1391, 1340, 1328, 1276, 1252, 1114, 1057, 1037, 1021, 977, 816, 766, 749, 692, 609, 549;

Results of EIMS mass spectroscopy m/z: 326 (M⁺);

Theoretical value from elementary analysis C₂₂H₁₈N₂O: C, 80.96; H, 5.56; N, 8.58.

Found: C, 80.95; H, 5.72; N, 8.54. 2-(2-Methoxyphenyl)-3-(4-methylphenyl)quinoxaline (3g)

White solid; m.p.: 137 to 138° C.;

¹H NMR (CDCl₃, 300 MHz): δ [ppm]: 8.15-8.20 (m, 2H), 7.72-7.78 (m, 2H), 7.63 (dd, J=7.5, 1.8 Hz, 1H), 7.35-7.41 (m, 3H), 7.06-7.15 (m, 3H), 6.73 (d, J=8.1 Hz, 1H), 3.25 (s, 3H), 2.32 (s, 3H)

¹³C NMR (CDCl₃, 75.5 MHz): δ [ppm]: 156.3, 154.6, 152.2, 141.3, 141.0, 138.2, 136.6, 130.8, 130.4, 129.5, 129.2, 129.1, 128.5, 128.3, 121.1, 111.1, 54.9, 21.3;

Infrared analysis result (KBr, cm⁻¹): 3058, 2998, 2932, 2831, 1598, 1583, 1493, 1463, 1434, 1394, 1346, 1278, 1251, 1163, 1119, 1062, 1020, 979, 827, 804, 764, 687, 610, 602, 545, 523;

Results of EIMS mass spectroscopy m/z: 326 (M⁺);

Theoretical value from elementary analysis C₂₂H₁₈N₂O: C, 80.96; H, 5.56; N, 8.58.

Found: C, 80.75; H, 5.60; N, 8.52.

TABLE 4

| Ar | Yield (%) |
|---|---|
| Ph | 92 (1a) |
| 4-MeC₆H₄ | 91 (1b) |
| 4-MeC₆H₄ | 91 (1c) |
| 2-MeC₆H₄ | 79 (1d) |
| 2-MeC₆H₄ | 91 (1e) |
| 2-CF₃C₆H₄ | 77 (1f) |
| 1-Naphthyl | 84 (1g) |

TABLE 5

| | Yield of Compound 2 | | Yield of Derivative 3 |
|---|---|---|---|
| Ar₁ | (%) | Ar₂ | (%) |
| Ph | 69 (2a) | 4-MeC₆H₄ | 93 (3a) |
| Ph | 69 (2a) | 4-MeC₆H₄ | 88 (3b) |
| 2-MeC₆H₄ | 85 (2b) | Ph | 96 (3c) |
| 2-MeC₆H₄ | 85 (2b) | 4-MeC₆H₄ | 91 (3d) |
| 2-MeC₆H₄ | 85 (2b) | 4-MeC₆H₄ | 90 (3e) |
| 2-MeC₆H₄ | 85 (2b) | 4-MeC₆H₄ | 95 (3f) |
| 2-MeC₆H₄ | 85 (2c) | 4-MeC₆H₄ | 91 (3g) |

TABLE 6

| | | | Reduction |
|---|---|---|---|
| | | Emitting | Potential |
| | Absorption Wavelength^{a} | Wavelength^{a} | (V)^{b} |
| Compound | λ (nm) (log ε) | λmax (nm) | E_{1/2}^{red} |
| 1a | 233 (6.0), 258 (5.7), 282 (5.6), 322 (5.3) | 350 | −2.04 |
| 1b | 233 (6.1), 259 (5.7), 283 (5.6), 322 (5.3) | 351 | −2.07 |
| 1c | 233 (6.0), 258 (5.6), 282 (5.6), 321 (5.2) | 355 | −2.09 |
| 1d | 232 (5.6), 258 (5.3), 281 (5.2), 321 (5.0) | 351 | −2.10 |
| 1e | 234 (5.2), 262 (5.1), 282 (5.0), 330 (4.5) | 348 | −2.12 |
| 1f | 232 (5.8), 259 (5.5), 282 (5.4), 321 (5.0) | 347 | −1.99 |
| 1g | 230 (5.7), 257 (5.3), 287 (5.2), 323 (4.8) | 348 | −2.02 |
| 3a | 230 (5.8), 262 (5.4), 332 (4.7) | 347 | −2.06 |
| 3b | 230 (5.5), 268 (5.1), 331 (4.4), 360 (4.3) | 349 | −2.06 |
| 3c | 241 (4.9), 262 (4.8), 334 (4.4) | 347 | −2.06 |
| 3d | 237 (5.6), 260 (5.3), 324 (4.9), 360 (4.4) | 348 | −2.07 |
| 3e | 237 (5.5), 259 (5.3), 280 (5.2), 322 (5.0) | 349 | −2.08 |
| 3f | 237 (5.1), 322 (4.6) | 295 | −2.12 |
| 3g | 236 (5.8), 258 (5.7), 280 (5.6), 306 (5.5) | 294 | −2.10 |

^{a}Measured in a dichloromethane solution at a concentration of 1 × 10⁻⁶M at 298 K;
^{b}Measured in an acetonitrile solution at a concentration of 1 × 10⁻³M using Cp₂Fe/Cp₂Fe⁺ as a standard substance, and Ag/AgCl as a reference electrode.

### Synthetic Example 7

Synthesis of asymmetric-type 2-monosubstituted quinoxaline derivatives

(1) Synthesis of 2-phenylquinoxaline

### {monosubstituted quinoxaline derivative [22a]}

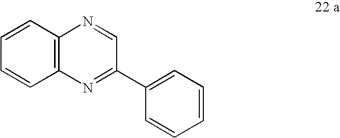

1,2-Phenylenediamine (2.163 g, 20.0 mmol), and phenylglyoxal (2.683 g, 20.0 mmol) were heated to reflux for 4 hours in a solvent of 50 mL of ethanol. After the solvent was distilled off, the resulting solid was recrystallized from hot hexane to afford 2-phenylquinoxaline [22a]as a colorless crystal (3.852 g,yield 93%).

m.p.: 77° C.;

¹H NMR (CDCl₃, 300 MHz): δ [ppm]: 7.53-7.61 (m, 3H) 7.73-7.82 (m, 2H), 8.11-8.22 (m, 4H), 9.34 (s, 1H);

¹³C NMR (CDCl₃, 75.5 MHz) δ [ppm]: 127.5, 129.0, 129.1, 129.4, 129.5, 130.1, 130.2, 136.7, 141.5, 142.2, 143.2, 143.3.

### (2) Synthesis of 2-(4-fluorophenyl)quinoxaline {monosubstituted quinoxaline derivative [22b]}

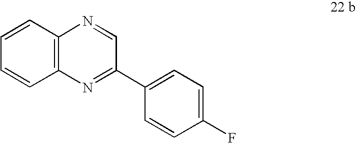

In an argon atmosphere, 2-chloroquinoxaline (1.646 g, 10.0 mmol), 4-fluorobenzeneboronic acid (1.539 g, 11.0 mmol), and Pd(PPh₃)₄ (0.289 g, 0.25 mmol) which acts as a coupling catalyst were heated to reflux for 24 hours in a solvent of 15 mL of toluene and 15 mL of a 2.0M aqueous potassium carbonate solution. After the solvent was distilled off, purification by silica gel column chromatography (eluent: ethyl acetate/hexane=1/5) afforded 2-(4-fluorophenyl)quinoxaline [22b](2.168 g, yield 97%) as a colorless crystal.

m.p.: 122° C.;

¹H NMR (CDCl₃, 300 MHz): δ [ppm]: 7.12-7.18 (m, 2H) 7.63-7.71 (m, 2H), 7.99-8.12 (m, 4H), 9.18 (s, 1H);

¹³C NMR (CDCl₃, 75.5 MHz): δ [ppm]: 116.1 (J=22 Hz), 129.0, 129.3 (J=5.4 Hz), 129.5 (J=3.4 Hz), 130.3, 132.8, 141.3, 142.0, 142.8, 150.6, 164.1 (J=250 Hz).

### (3) Synthesis of 2-(3,5-difluorophenyl)quinoxaline {monosubstituted quinoxaline derivative [22c]}

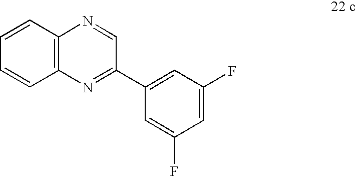

In an argon atmosphere, 2-chloroquinoxaline (1.646 g, 10.0 mmol), 3,5-difluorobenzeneboronic acid (2.837 g, 111.0 mmol), and Pd(PPh₃)₄ (0.289 g, 0.25 mmol) which acts as a coupling catalyst were heated to reflux for 24 hours in a solvent of 15 mL of toluene and 15 mL of a 2.0M aqueous potassium carbonate solution. After the solvent was distilled off, the residue was purified by silica gel column chromatography (eluent: ethyl acetate/hexane=1/5), and the pure product, 2-(3,5-difluorophenyl)quinoxaline [21c](1.802 g, yield 74%) was obtained by recrystallization of the resulting solid from hot ethanol.

¹H NMR (CDCl₃, 300 MHz): δ[ppm]: 7.81-7.90 (m, 2H), 8.03 (brs, 1H), 8.16-8.25 (m, 2H), 8.70 (s, 1H), 9.40 (s, 1H)

### Synthetic Example 8

### Synthesis of tris[(2,3-diphenyl)quinoxalyl-N,C²]iridium

### {tris-type organometallic compound [21a]}

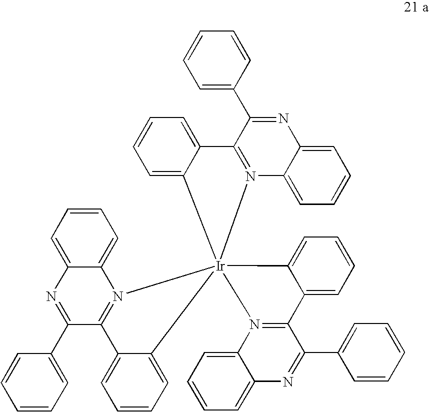

In an argon atmosphere, bis(2,3-diphenylquinoxalyl-N, C²′) (2,4-pentanedionato-κO, κO′)iridium {(1,3-dionato-κO, κO′) organometallic compound [20a]} (170.8 mg,0.20 mmol), and diphenylquinoxaline {quinoxaline derivative [18a]} (124.2 mg,0.44 mmol) corresponding to a 2-fold substance amount of the organometallic compound were heated and stirred at 200° C. for 48 hours from the suspended state in a solvent of 20 mL of degassed glycerin. After the reaction mixture was cooled to room temperature, the reaction mixture was poured into 100 mL of 11.0M hydrochloric acid, this was extracted with dichloromethane and the organic layer was dried with anhydrous magnesium sulfate. The solvent was distilled off, the residue was purified by silica gel column chromatography (the materials were eluted by switching to higher polarity such as a eluent from, initially, ethyl acetate/hexane=1/2, subsequently ethyl acetate—dichloromethane, and subsequently dichloromethane/methanol=10/1), and the resulting solid was washed with 20 mL of ethanol to obtain tris[2,3-diphenyl-quinoxalyl-N,C²′]iridium (III) [21a]as a red solid (78.8 mg,yield 37%)

m.p.: higher than 300° C.;

¹H NMR (CDCl₃, 300 MHz): δ [ppm]: 5.65 (d, J=7.9 Hz, 1H), 6.21 (t, J=7.9 Hz, 1H), 6.47 (t, J=7.9 Hz, 1H), 6.73 (t, J=7.9 Hz, 1H), 6.87 (d, J=7.9 Hz, 1H), 7.36 6.21 (t, J=7.9 Hz, 1H), 7.67-7.83 (m, 4H), 8.01-8.17 (m, 2H), 8.40 (d, J=7.9 Hz, 1H).

### Synthetic Example 9

### Synthesis of tris[2,3-bis(4-fluorophenyl)quinoxalyl-N,C²′]iridium {tris-type organometallic compound [21b]}

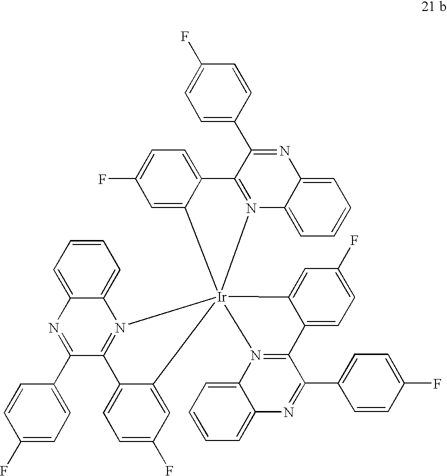

In an argon atmosphere, bis[2,3-bis(4-fluorophenyl)quinoxalyl-N,C²′](2,4-pentanedio nato-κO,κO′)iridium{(1,3-dionato-κO,κO′) organometallic compound [20b]} (185.2 mg, 0.20 mmol), and 2,3-bis(4-fluorophenyl)quinoxaline{quinoxaline derivative [18b]} (127.3 mg, 0.40 mmol) corresponding to a 2-fold substance amount of the organometallic compound were heated and stirred at 200° C. for 48 hours from the suspended state in a solvent of 20 mL of degassed glycerin. After the reaction mixture was cooled to room temperature, the reaction mixture was poured into 100 mL of 1.0M hydrochloric acid, this was extracted with dichloromethane, and the organic layer was dried with anhydrous magnesium sulfate. After the solvent was distilled off, the residue was purified by silica gel column chromatography (the materials were eluted using a eluent of an initial mixing ratio of ethyl acetate/hexane=1/5 and, thereafter, by switching the ratio to 1/2), and the resulting solid was washed with 10 mL of diethyl ether to obtain tris[2,3-bis(4-fluorophenyl)quinoxalyl]-N,C²′]iridium [21b] (37.5 mg, yield 16%) as an orange solid.

### Application Example 1

On a glass substrate on which an anode composed of In₂O₃—SnO₂ (ITO) had been formed in advance, an organic layer or plural organic layers and, subsequently, lithium fluoride (LiF) as a second electron injection layer and, further, a cathode composed of aluminum were formed by a deposition method in a vacuum of 10⁻⁴ Pa level, thereby, a light emitting element was prepared.

After a layer composed of 4,4′-bis[N-(1-naphthyl)-N-phenyl-amino]biphenyl (NPB) shown by Chemical Formula 25 was formed as a hole transport layer on an anode surface composed of ITO, a layer constructed as a mixture of 4,4′-bis(carbazol-9-yl)-biphenyl (CBP) shown by Chemical Formula 26 and a light emitting dopant was formed as a mixture light emitting layer, then, a layer composed of 2,9-dimethyl-4,7-diphenyl-1,10-phenanthroline (BCP) shown by Chemical Formula 27 was formed as a hole blocking layer, a layer composed of aluminum tris(8-hydroxyquinoline) (Alq) shown by Chemical Formula 28 was formed as a first electron injection layer, and a lithium fluoride (LiF) layer as a second electron injection layer and an aluminum layer to compose a cathode was deposited to prepare a light emitting element. As an average content of each component in the mixture light emitting layer, CBP was 92% by mass, and the light emitting dopant was 8% by mass. A film thickness of each layer obtained with a quartz oscillator film thickness meter is shown in a parenthesis of the following formula.

ITO/NPB(23 nm)/mixture light emitting layer(20 nm)/BCP(5 nm(Alq(25 nm)/LIF(0.5 nm)/Al(300 nm).

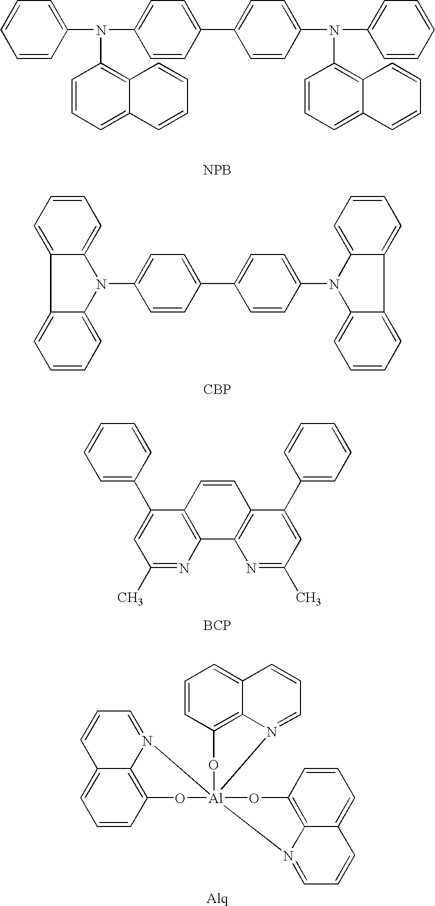

Using bis(2,3-diphenylquinoxalyl-N,C²′) (2,4-pentanedionato-κO,κO′)iridium

{(1,3-dionato-κO,κO′) organometallic compound [20a]} as a light emitting dopant, a light emitting element was prepared.

A light emitting initiation voltage defined as an application voltage at which a light emitting luminance becomes lcd/m² or higher was 4.2V, and red emission of an extremely high chroma saturation having a luminance of 373 cd/m² was obtained at application of 7V. A light emitting peak wavelength was 672 nm, and chromaticity coordinates by a measuring format defined in Commission International d'Eclairage (CIE) were (x=0.60,y=0.34).

As compared with the fact that only emission of an orange color having CIE chromaticity coordinates of x of 0.60 to 0.63, and y of 0.37 to 0.40 were obtained in the prior art disclosed in the document, Advanced Materials, 2003, 15(3), 224-228, a value of y axis in CIE chromaticity coordinates was considerably improved in the aforementioned Application Example. According to the technique of the present invention, a color which is sufficiently satisfactory to an ordinary people was realized, from a viewpoint of practice in utility of display indication.

### Application Example 2

By applying the same structure and process as those of Application Example 1 except that the light emitting dopant was changed to bis[2,3-bis(4-fluorophenyl)quinoxalyl-N, C²′](2,4-pentanedio nato-κO,κO′)iridium

{(1,3-dionato-κO,κO′) organometallic compound [20b]}, a light emitting element was prepared.

A light emitting initiation voltage was 3.6V, and red emission of an extremely high chroma saturation having a luminance of 339 cd/m² was obtained at application of 7V. A light emitting peak wavelength was 640 nm, and a CIE chromaticity coordinate was (x=0.67,y=0.30). CIE chromaticity coordinates of a primary red color defined in television broadcasting standard according to NTSC (National Television System Committee) are (x=0.67,y=0.33). Therefore, an approximately complete color was realized, from a viewpoint of practice in utility of display indication.

### Application Example 3

By applying the same structure and process as those of Application Example 1 except that the light emitting dopant was changed to bis[2,3-bis(4-methylphenyl)quinoxalyl-N,C²](2,4-pentanedio nato-κO,κO′) iridium

{(1,3-dionato-κO,κO′) organometallic compound [20c]}, a light emitting element was prepared.

A light emitting initiation voltage was 3.6V, and red emission of a high chroma saturation having a luminance of 391 cd/m² was obtained at application of 7V. A light emitting peak wavelength was 667 nm, and CIE chromaticity coordinates were (x=0.62,y=0.34).

### Application Example 4

By applying the same structure and process as those of Application Example 1 except that the light emitting dopant was changed to bis[2,3-bis(4-methoxyphenyl)quinoxalyl-N,C²′](2,4-pentanedionato-κO,κO′) iridium{(1,3-dionato-κO,κO′) organometallic compound [20d]}, a light emitting element was prepared.

A light emitting initiation voltage was 3.6V, and red emission of a high chroma saturation having a luminance of 385 cd/m² was obtained at application of 7V. A light emitting peak wavelength was 657 nm, and CIE chromaticity coordinates were (x=0.64,y=0.34).

### Application Example 5

By applying the same structure and process as those of Application Example 1 except that the light emitting dopant was changed to tris[2,3-bis(4-fluorophenyl)quinoxalyl-N,C²′]]iridium

{tris-type organometallic compound [21b]}, a light emitting element prepared.

A light emitting initiation voltage was 3.5V, and red emission of an extremely high chroma saturation having a luminance of 410 cd/m² was obtained at application of 7V. A light emitting peak wavelength was 641 nm, and a CIE chromaticity coordinate was (x=0.66,y=0.33). Since CIE chromaticity coordinates of a primary red color prescribed in NTSC television broadcasting standard are (x=0.67,y=0.33), an approximately complete color was realized, from a viewpoint of practice in utility of display indication.

### Application Example 6

By applying the same structure and process as those of Application Example 1 except that the light emitting dopant was changed to tris[2,3-diphenyl-quinoxalyl-N,C²′]]iridium

{tris-type organometallic compound [21a]}, a light emitting element prepared.

A light emitting initiation voltage was 3.5V, and red emission of an extremely high chroma saturation having a luminance of 403 cd/m² was obtained at application of 7 V. A light emitting peak wavelength was 652 nm, and CIE chromaticity coordinates were (x=0.65,y=0.33). Since CIE chromaticity coordinates of a primary red color prescribed in NTSC television broadcasting standard are (x=0.67,y=0.33), an approximately complete color was realized, from a viewpoint of practice in utility of display indication.

1. An organometallic compound comprising a quinoxaline structure, and having a structure represented by the following general formula (1), 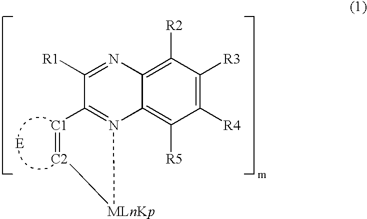
wherein M represents a monovalent to trivalent metal, L and K represent a ligand coordinating on a metal M, E represents a cyclic structure, R1 to R5 represent a hydrogen atom or an arbitrary substituent, and may be the same or different, m represents a integer of 1 to 3, n represents an integer of 0 to 3, p represents an integer of 0 to 2, and m+n+p is equal to an integer of 2 to 5.

2. The organometallic compound according to claim 1, wherein E in the general formula (1) is a substituted or unsubstituted aryl group, a substituted or unsubstituted heterocyclic group, a substituted or unsubstituted fused polycyclic aromatic group or a substituted or unsubstituted fused polycyclic heterocyclic group.

3. The organometallic compound according to claim 1, wherein R1 in the general formula (1) is a substituent of a carbon number of 4 or more.

4. The organometallic compound according to claim 1, wherein m in the general formula (1) is 3, and n and p are 0.

5. The organometallic compound according to claim 1, wherein M in the general formula (1) is Ir, Pt, Re or Os.

6. The organometallic compound according to claim 1, wherein L and K in the general formula (1) are a ligand comprising a dicarbonyl compound or a tautomer thereof.

7. A light emitting element comprising an organometallic compound as defined in clam 1.

8. The light emitting element according to claim 7, which is an organic electroluminescent element.

9. An organometallic compound comprising a quinoxaline structure, and having a structure represented by the following general formula (2), 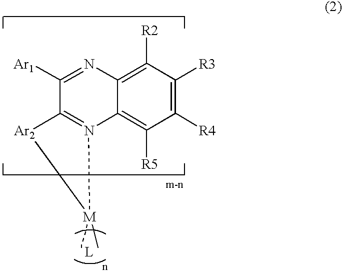
wherein M represents a monovalent to trivalent metal, L represent a ligand, Ar₁ and Ar₂ represent an aryl group in which a part of hydrogens may be substituted, and the same or different, R2 to R5 represent a hydrogen atom or a arbitrary constituent, m represents an integer of 1 to 3, n represents an integer of 0 to 2, and m-n is an integer of 1 to 3.

10. The organometallic compound according to claim 9, wherein m in the general formula (2) is 3, and n is 0.

11. The organometallic compound according to claim 9, wherein M in the general formula (2) is Ir, Pt, Re or Os.

12. The organometallic compound according to claim 9, wherein L in the general formula (2) is a ligand comprising a dicarbonyl compound or a tautomer thereof.

13. A light emitting element comprising an organometallic compound as defined in claim 9.

14. The light emitting element according to claim 13, which is an organic electroluminescent element.
